(19) United States
(12) Patent Application Publication
(10) Pub. No.: US 2026/0271105 A1
(43) Pub. Date: Sep. 10, 2026

(54) ESTABLISHING A MULTIACCESS DATA CONNECTION IN A WIRELESS COMMUNICATION SYSTEM

(71) Applicant: Lenovo (Singapore) Pte. Limited, Singapore (SG)

(72) Inventor: Apostolis Salkintzis, Glika Nera (GR)

(73) Assignee: Lenovo (Singapore) Pte. Limited, Singapore (SG)

(21) Appl. No.: 19/166,724

(22) PCT Filed: May 9, 2023
(86) PCT No.: PCT/EP2023/062178

§ 371 Date: Sep. 18, 2025

(30) Foreign Application Priority Data
Mar. 24, 2023 (GR) 20230100248

(51) Int. Cl. H04W 76/12; H04W 28/02; H04W 88/06

(52) U.S. Cl. CPC H04W 76/12; H04W 28/0236; H04W 88/06

(57) ABSTRACT

There is provided a user equipment apparatus for wireless communication, comprising a processor and a memory coupled with the processor, the processor configured to cause the user equipment apparatus to: receive, from a first application, a first request for a data connection, wherein the first request comprises one or more required connection capabilities; determine, based on the first request, that a multiaccess data connection is required for the data connection; transmit, to a mobile core network of a wireless communication network, a second request for establishing the multiaccess data connection, wherein the second request comprises one or more traffic requirements that are based on the one or more required connection capabilities; and receive, from the mobile core network, a response to the second request, wherein the response comprises one or more steering rules for steering uplink traffic across a plurality of accesses of the multiaccess data connection, the one or more steering rules being based on the one or more traffic requirements.

### FIELD

The subject matter disclosed herein relates generally to the field of implementing the establishing of a multiaccess data connection in a wireless communication system. This document defines a user equipment apparatus for wireless communication, a first apparatus in a wireless communication network, a second apparatus in a wireless communication network, and methods in said user equipment apparatus, first apparatus and second apparatus.

### INTRODUCTION

A user equipment (UE) in a wireless communication system can receive requests from internal applications (App) for data connections with one or more connection capabilities, e.g., with capability to support high-bandwidth, or with capability to support low-latency. Such connection capabilities are already supported by modem UEs. Android, for example, enables apps to request data connections capable of supporting one or more capabilities, called “network capabilities”, which include Internet capability, MMS capability, MMTEL (Multimedia Telephony) capability, high-bandwidth capability, low-latency capability, etc. A full list of such capabilities in Android can be found at https://developer.android.com/reference/android/net/NetworkCapabilities.

After receiving a request from an app, the UE (typically in the Operating System layer) processes the provisioned UE Route Selection Policy (URSP) rules and finds a rule matching the request. This matching rule may then indicate that a new data connection (aka protocol data unit (PDU) Session) should be established using multiple accesses simultaneously, such as NG-RAN access and WiFi access. For example, the UE may be provisioned with a URSP rule indicating that “when a data connection is requested with connection capability equal to high-bandwidth, then a MA PDU session should be established.” This rule aims at satisfying the high-bandwidth requirement by using multiple accesses and aggregating their bandwidths.

For a 5G-capable UE, a multiaccess (MA) data connection may then be established between the 5G-capable UE and a 5G Core (5GC) network. This MA data connection is referred to in the Third Generation Partnership Project (3GPP) specifications as a MA PDU Session.

### SUMMARY

A UE may send a MA PDU Session Establishment Request message to a 5GC, triggered by a URSP rule matching a request, from an application, for a data connection. The 5GC processes this message and creates steering rules that specify how the uplink (UL) and downlink (DL) traffic should be routed across the multiple accesses of the MA PDU Session. Subsequently, a MA PDU Session Establishment Accept message is sent to the UE including Access Traffic Steering, Switching, Splitting (ATSSS) rules, which specify how the UL traffic should be routed across the multiple accesses. Similar rules, called N4 multiaccess rules (MAR), or N4 rules for short, are provided to a UPF in 5GC, which specify how the DL traffic should be routed across the multiple accesses. By using the ATSSS rules in the UE and the N4 rules in the UPF, the UL and the DL traffic respectively is routed across the multiple accesses of the MA PDU Session.

The steering rules of the MA PDU Session are created in a Policy Control Function (PCF) inside the 5GC by considering only pre-configured policy and possibly UE subscription information. The PCF does not consider why the MA PDU Session was requested and whether it should fulfil specific capabilities requested by an application. For example, the PCF does not know that the MA PDU Session was triggered, for instance, by a certain application in the UE, which wants high-bandwidth connectivity. Therefore, the PCF may not be able to create steering rules suitable for fulfilling the high-bandwidth requirements of the application. The pre-configured policy in the PCF that is used to create the steering rules, may not contain requirements for the application and, even if it does, it may contain different requirements from those requested by the application in a given scenario (i.e., high-bandwidth requirement).

In general, when a MA PDU Session is established according to the current 3GPP specifications (see, e.g., TS 23.501), the steering rules of the MA PDU Session are created without considering potential connection capabilities that triggered the need for this MA PDU Session and, therefore, the created steering rules may not be able to fulfil these connection capabilities. For example, in the example described above, the application may have requested high-bandwidth capabilities, but the created steering rules may route the UL and DL traffic of the application over WiFi only. If the PCF knew about the high-bandwidth requirement of the application, it could have created steering rules that route the UL and DL traffic of the application over both NG-RAN and WiFi simultaneously, using a load-balancing steering mode.

The objective of the present disclosure is to resolve the above issues by proposing enhancements to the MA PDU Session establishment procedure.

Disclosed herein are procedures for establishing a multiaccess data connection in a wireless communication system. Said procedures may be implemented by a user equipment apparatus for wireless communication, a first apparatus in a wireless communication network, a second apparatus in a wireless communication network, and methods in said user equipment apparatus, first apparatus and second apparatus.

There is provided, a user equipment apparatus for wireless communication, comprising a processor; and a memory coupled with the processor, the processor configured to cause the user equipment apparatus to: receive, from a first application, a first request for a data connection, wherein the first request comprises one or more required connection capabilities; determine, based on the first request, that a multiaccess data connection is required for the data connection; transmit, to a mobile core network of a wireless communication network, a second request for establishing the multiaccess data connection, wherein the second request comprises one or more traffic requirements that are based on the one or more required connection capabilities; and receive, from the mobile core network, a response to the second request, wherein the response comprises one or more steering rules for steering uplink traffic across a plurality of accesses of the multiaccess data connection, the one or more steering rules being based on the one or more traffic requirements.

There is further provided, a first apparatus in a wireless communication network, comprising a processor and a memory coupled with the processor, the processor configured to cause the first apparatus to: receive, from a session management function ‘SMF’ in the wireless communication network, a request for a session management policy for a multiaccess data connection, wherein the request comprises one or more traffic requirements that are based on one or more required connection capabilities; generate, based on the traffic requirements, one or more session management policy rules for steering traffic of the multiaccess data connection across a plurality of accesses of the multiaccess data connection; and transmit, to the SMF, a response to the request for the session management policy, wherein the response comprises the one or more session management policy rules for steering the traffic of the multiaccess data connection.

There is further provided, a second apparatus in a wireless communication network, comprising a processor; and a memory coupled with the processor, the processor configured to cause the second apparatus to: transmit, to a policy control function ‘PCF’ in the wireless communication network, a request for a session management policy for a multiaccess data connection, wherein the request comprises one or more traffic requirements that are based on one or more required connection capabilities; receive, from the PCF, a response to the request for the session management policy, wherein the response comprises one or more session management policy rules for steering the traffic of the multiaccess data connection across a plurality of accesses of the multiaccess data connection; and generate, based on the one or more session management policy rules, one or more steering rules for steering the traffic of the multiaccess data connection.

There is further provided, a method in a user equipment apparatus for wireless communication, comprising: receiving, from a first application, a first request for a data connection, wherein the first request comprises one or more required connection capabilities; determining, based on the first request, that a multiaccess data connection is required for the data connection; transmitting, to a mobile core network of a wireless communication network, a second request for establishing the multiaccess data connection, wherein the second request comprises one or more traffic requirements that are based on the one or more required connection capabilities; and receiving, from the mobile core network, a response to the second request, wherein the response comprises one or more steering rules for steering uplink traffic across a plurality of accesses of the multiaccess data connection, the one or more steering rules being based on the one or more traffic requirements.

There is further provided, a method in a first apparatus in a wireless communication network, comprising: receiving, from a SMF in the wireless communication network, a request for a session management policy for a multiaccess data connection, wherein the request comprises one or more traffic requirements that are based on one or more required connection capabilities; generating, based on the traffic requirements, one or more session management policy rules for steering traffic of the multiaccess data connection across a plurality of accesses of the multiaccess data connection; and transmitting, to the SMF, a response to the request for a session management policy, wherein the response comprises the one or more session management policy rules for steering the traffic of the multiaccess data connection.

There is further provided, a method in a second apparatus in a wireless communication network, comprising: transmitting, to a PCF in the wireless communication network, a request for a session management policy for a multiaccess data connection, wherein the request comprises one or more traffic requirements that are based on one or more required connection capabilities; receiving, from the PCF, a response to the request for the session management policy, wherein the response comprises one or more session management policy rules for steering the traffic of the multiaccess data connection across a plurality of accesses of the multiaccess data connection; and generating, based on the one or more session management policy rules, one or more steering rules for steering the traffic of the multiaccess data connection.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for establishing a multiaccess data connection in a wireless communication system will now be described, by way of example only, with reference to the accompanying drawings, in which:

FIG. 1 illustrates an embodiment of a wireless communication system;

FIG. 2 illustrates an embodiment of a user equipment apparatus;

FIG. 3 illustrates an embodiment of a network node;

FIG. 4 illustrates a prior art example of a multiaccess data connection being established;

FIG. 5 illustrates an embodiment of UE connected to a 5GC network via two types of access networks (accesses);

FIG. 6 illustrates an embodiment of a method in a user equipment apparatus;

FIG. 7 illustrates an embodiment of a method in a first apparatus;

FIG. 8 illustrates an embodiment of a method in a second apparatus; and

FIG. 9 illustrates an embodiment of an MA PDU establishment procedure.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

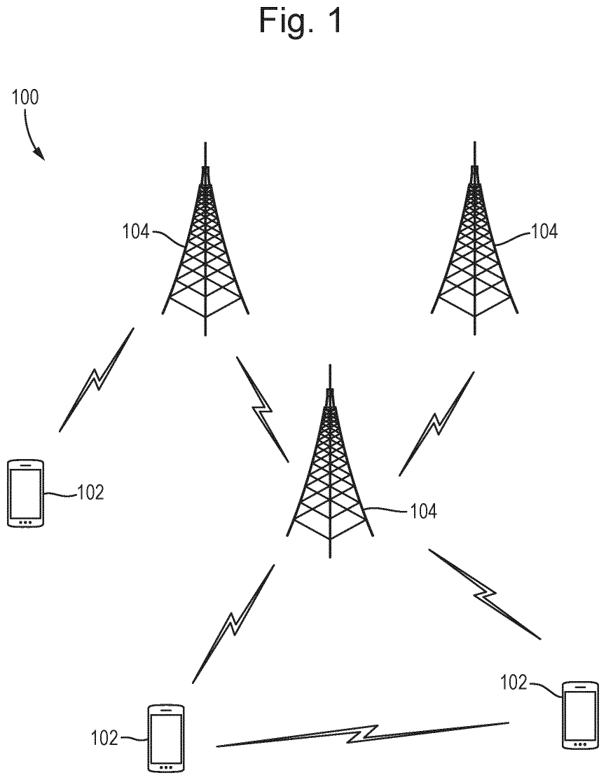

FIG. 1 depicts an embodiment of a wireless communication system 100 for establishing a multiaccess data connection. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

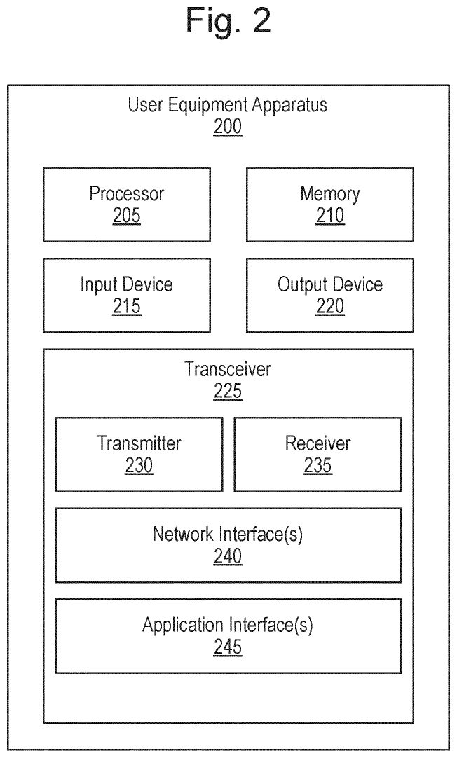

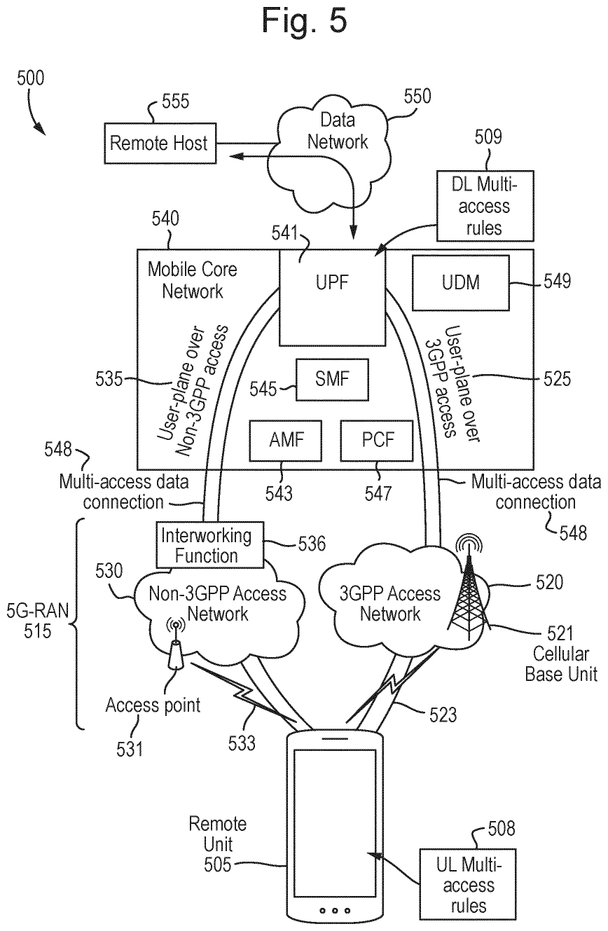

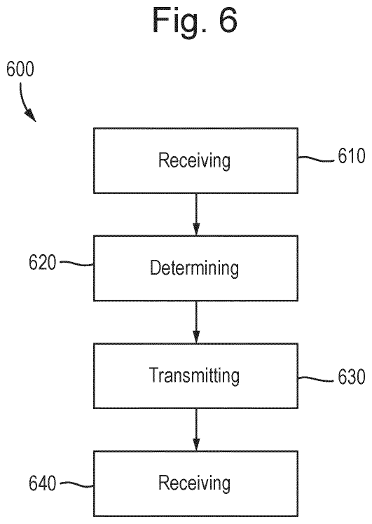

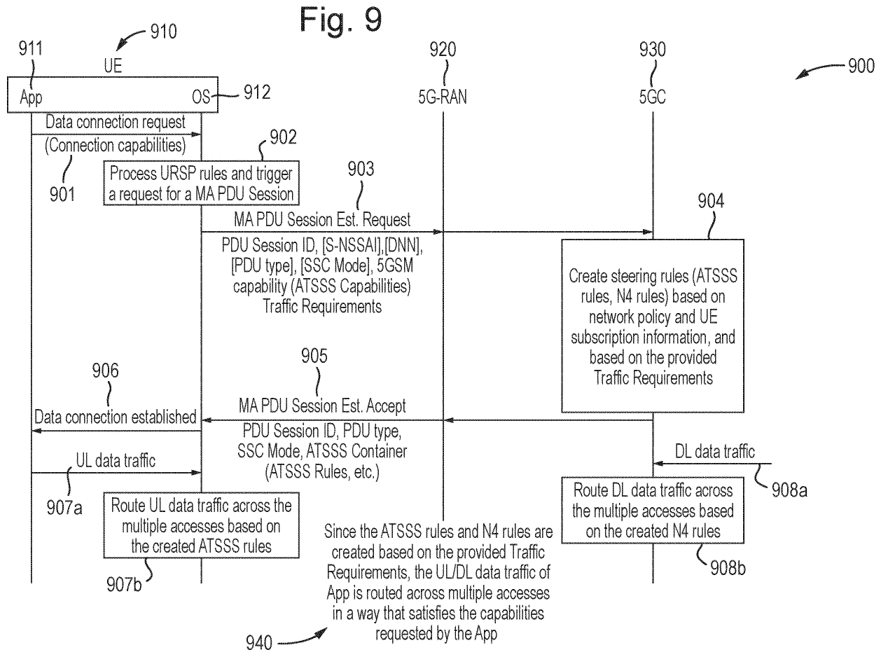

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise the remote unit 505 of FIG. 5, a UE performing the method illustrated in FIG. 6, or the UE 910 of FIG. 9. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

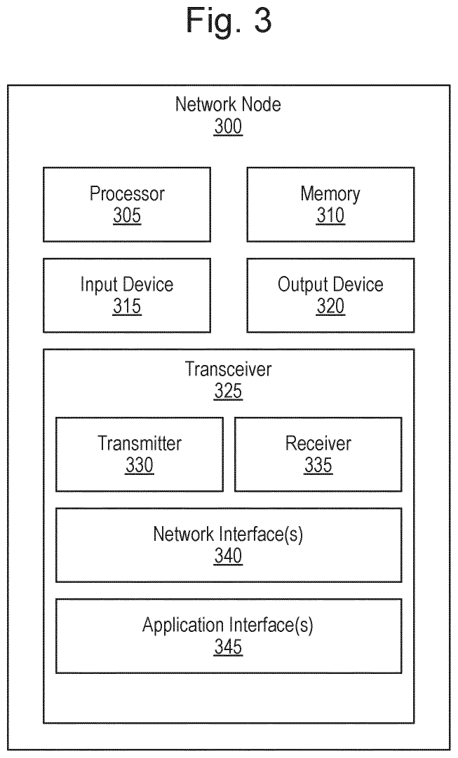

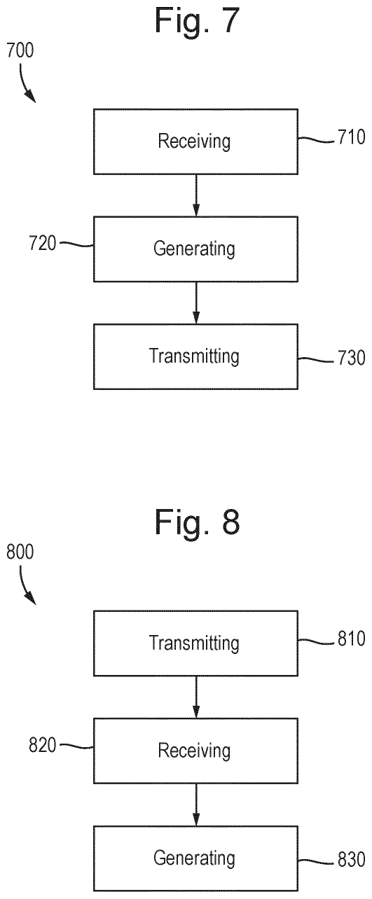

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise the SMF 545 or PCF 547 of FIG. 5, a PCF performing the method illustrated in FIG. 7, an SMF performing the method illustrated in FIG. 8, a PCF or SMF in 5GC 930 of FIG. 9. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

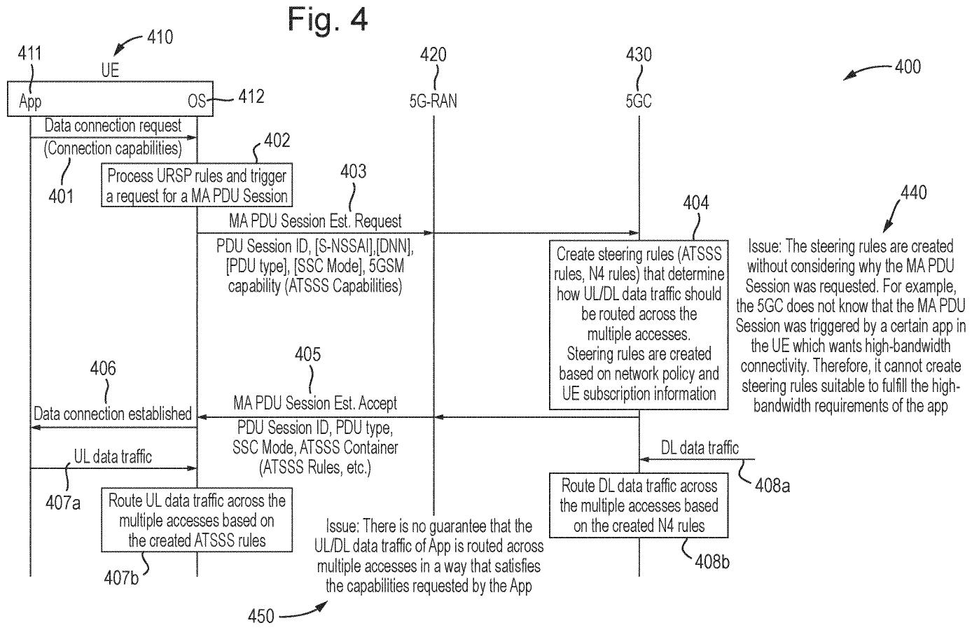

FIG. 4 illustrates a prior art example 400 of a multiaccess data connection being established between a 5G capable UE and a 5GC network. The MA data connection is referred to in 3GPP as a MA PDU session. The example 400 shows a UE 410 comprising an application 411 and an operating system 412. Further illustrated is a 5G-RAN 420 and a 5GC network 430. The various steps illustrated in the example 400 will now be described.

In a first step 401, the UE 410 operating system 412 receives a request from an internal application 411, which requests a data connection with one or more connection capabilities, e.g., with capability to support high-bandwidth, or with capability to support low-latency. As discussed herein, such kinds of connection capabilities are already supported by modern UEs, for example Android enables applications to request data connections capable of supporting one or more capabilities, called “network capabilities”, which include Internet capability, MMS capability, MMTEL (Multimedia Telephony) capability, high-bandwidth capability, low-latency capability, etc. This first step 401 is illustrated as, ‘data connection request (connection capabilities)’.

In a further step 402, after receiving the request from the application, the UE 410 (typically in the Operating System layer—412) processes the provisioned UE Route Selection Policy (URSP) rules and finds a rule matching the request. This matching rule may indicate that a new data connection (aka PDU Session) should be established using multiple accesses simultaneously, such as NG-RAN access and WiFi access. For example, the UE 410 may be provisioned with a URSP rule indicating that “when a data connection is requested with connection capability equal to high-bandwidth, then a MA PDU session should be established.” This rule aims at satisfying the high-bandwidth requirement by using multiple accesses and aggregating their bandwidths. This step 402 is illustrated as, ‘process URSP rules and trigger a request for a MA PDU session’.

In a further step 403, and triggered by the matching URSP rule, the UE 410 sends a MA PDU Session Establishment Request message to the 5GC 430 via 5G-RAN 420. This step 403 is illustrated as, ‘MA PDU Session Est. request, PDU Session ID, [S-NSSAI], [DNN], [PDU type], [SSC mode], 5GSM capability (ATSSS capabilities)’.

In a further step 404, the 5GC 430 processes the MA PDU session establishment request message and creates steering rules that specify how the UL and DL traffic should be routed across the multiple accesses of the MA PDU Session. This step 403 is illustrated as, ‘Create steering rules (ATSSS rules, N4 rules) that determine how UL/DL data traffic should be routed across the multiple accesses. Steering rules are created based on network policy and UE subscription information’.

In a further step 405, a MA PDU Session Establishment Accept message is sent to UE 410 via 5G-RAN 420 including Access Traffic Steering, Switching, Splitting (ATSSS) rules, which specify how the UL traffic should be routed across the multiple accesses. This step 405 is illustrated as, ‘MA PDU session est. accept, PDU session ID, PDU type, SSC mode, ATSSS container (ATSSS rules, etc)’. Similar rules, called N4 rules, are provided to a UPF in 5GC 430, which specify how the DL traffic should be routed across the multiple accesses.

In a further step 406, a data connection is established.

In further steps 407a-407b, and 408a-408b, by using the ATSSS rules in the UE 410 and the N4 rules in the UPF of 5GC 430, the UL and the DL traffic respectively is routed across the multiple accesses of the MA PDU Session. The further steps 407a-407b are illustrated as, ‘UL data traffic’ and ‘route UL data traffic across the multiple accesses based on the created ATSSS rules’ respectively. The further steps 408a-408b are illustrated as, ‘DL data traffic’ and ‘route DL data traffic across the multiple accesses based on the created N4 rules’, respectively.

The prior art example 400 illustrated does however have two issues, as indicated at 440 and 450. In particular, the first issue 440 is that the steering rules are created at the 5GC 430 without considering why the MA PDU session was requested. For example, the 5GC 430 does not know that the MA PDU session was triggered by a certain application 411 in the UE 410 which wants high-bandwidth connectivity. Therefore, it cannot create steering rules suitable to fulfill the high bandwidth requirements of the application 411. A second issue 450 is that there is no guarantee that the UL/DL data traffic of the application 411 is routed across the multiple accesses in away that satisfies the capabilities requested by the application 411.

More specifically, the steering rules of the MA PDU Session are created in a Policy Control Function (PCF) inside 5GC by considering only pre-configured policy and possibly UE subscription information. The PCF does not consider why the MA PDU Session was requested and whether it should fulfil specific capabilities requested by an application. For example 400, the PCF does not know that the MA PDU Session was triggered by the application 411 in the UE 410, which wants high-bandwidth connectivity. Therefore, it may not be able to create steering rules suitable to fulfil the high-bandwidth requirements of this application 411. The pre-configured policy in the PCF that is used to create the steering rules, may not contain requirements for this application 411 and, even if it does, it may contain different requirements from those requested by the application 411 in the example 400 (i.e., high-bandwidth).

It is emphasized that, in general, when a MA PDU Session is established according to the current 3GPP specifications (see, e.g., TS 23.501), the steering rules of the MA PDU Session are created without considering potential connection capabilities that triggered the need for this MA PDU Session and, therefore, the created steering rules may not be able to fulfil these connection capabilities. For the example 400, the application 411 may have requested high-bandwidth capabilities, but the created steering rules may route the UL and DL traffic of this application 411 over WiFi only. If the PCF knew about the high-bandwidth requirement of the application 411, it could have created steering rules that route the UL and DL traffic of this application over both NG-RAN 420 and WiFi simultaneously, using a load-balancing steering mode, for instance.

FIG. 5 illustrates an embodiment 500 of UE connected to a 5GC network via two types of access networks (accesses). The figure illustrates a remote unit 505 (UE) connected to a 5G core (5GC) network 540 via two types of access networks: (a) a 3GPP access network 520 and (b) a non-3GPP access network 530. The first type of access 520 uses a 3GPP-defined type of wireless communication (e.g., NG-RAN), while the second type of access 530 uses a non-3GPP-defined type of wireless communication (e.g., WLAN/WiFi). The 5G-RAN illustrated as 515 refers to any type of 5G access network that can provide access to 5GC 540, including the 3GPP access network 520 and the non-3GPP access network 530. The 3GPP access network 520 is illustrated as comprising a cellular base unit 521. The non-3GPP access network 530 is illustrated as comprising an access point 531.

The remote unit 505 (UE) can establish a multiaccess data connection 548 with a UPF 541 in 5GC 540, which can support data communication using multiple access types, such as the first access type 520 (e.g., NG-RAN) and the second access type 530 (e.g., WiFi access). The multiaccess data connection 548 is also known as multiaccess PDU Session and supports two user-plane connections: one user-plane connection using communication over 3GPP access 525 and another user-plane connection using communication over non-3GPP access 535. The user-plane connection using communication over non-3GPP access 535 utilises an interworking function 536. In general, a MA PDU Session may have two or more user-plane connections, each one using communication over a different type of access network. The 5GC network 540 further comprises an AMF 543, an SMF 545 and a UDM 549.

During the establishment of the MA PDU session 548, a PCF 547 creates PCC rules, which are provided to a SMF 545 that creates, based on the PCC rules, steering rules 508 for the Uplink (UL) traffic and steering rules 509 for the Downlink (DL) traffic, which are forwarded to the remote unit 505 and to UPF 541, respectively. The steering rules 508 for the Uplink (UL) traffic are called ATSSS rules, and the steering rules 509 for the Downlink (DL) traffic are called multiaccess N4 rules. The steering rules 508, 509 specify how the UL traffic and how the DL traffic of the MA PDU Session is to be routed across the two user-plane connections, or across the two types of accesses.

The remote unit 505 may use the MA PDU Session 548 to communicate with a Remote Host 555, connectable via a Data Network 550.

The disclosure herein provides, a user equipment apparatus for wireless communication, comprising a processor; and a memory coupled with the processor, the processor configured to cause the user equipment apparatus to: receive, from a first application, a first request for a data connection, wherein the first request comprises one or more required connection capabilities; determine, based on the first request, that a multiaccess data connection is required for the data connection; transmit, to a mobile core network of a wireless communication network, a second request for establishing the multiaccess data connection, wherein the second request comprises one or more traffic requirements that are based on the one or more required connection capabilities; and receive, from the mobile core network, a response to the second request, wherein the response comprises one or more steering rules for steering uplink traffic across a plurality of accesses of the multiaccess data connection, the one or more steering rules being based on the one or more traffic requirements.

The first application may be internal to the UE.

The second request may be a PDU Session Establishment request including a multiaccess indication, as currently defined in 3GPP specifications. The PDU session Establishment request may be received by an AMF and forwarded to an SMF.

In some embodiments, the processor is further configured to cause the user equipment apparatus to steer uplink traffic, using the one or more steering rules, across the plurality of accesses of the multiaccess data connection. The steering itself is performed in accordance with the one or more required connection capabilities.

In some embodiment, the processor is configured to cause the user equipment apparatus to determine that the multiaccess data connection is required, by causing the user equipment apparatus to: identify a user equipment route selection policy ‘URSP’ rule matching the first request; and determine based on the URSP rule, that the multiaccess data connection is required. Matching the first request means that the Traffic Descriptor component of the URSP rule matches (or comprises) with the one or more required connection capabilities.

In some embodiments, the one or more traffic requirements comprise one or more traffic descriptors of the URSP rule.

In some embodiments, the one or more traffic descriptors comprise traffic descriptors selected from the list of traffic descriptors consisting of: a high-bandwidth requirement; a low-latency requirement; and a high-reliability requirement.

In some embodiments, the one or more steering rules are access traffic steering, switching and splitting ‘ATSSS’ rules, wherein the ATSSS rules preferably comprise one or more steering modes selected from the list of steering modes consisting of: a load balancing steering mode; a smallest-delay steering mode; a redundant steering mode; an active-standby steering mode; and a priority-based steering mode.

In some embodiments, the multiaccess data connection is a multiaccess protocol data unit ‘MA PDU’ session.

In some embodiments, the processor is configured to cause the user equipment apparatus to: transmit the second request to a session management function ‘SMF’ of the mobile core network; and receive the response to the second request, from the SMF. The response to the second request may be an PDU Session Establishment Accept message.

In some embodiments, the processor is configured to cause the user equipment apparatus to transmit/receive the second request/response to the second request, via an access management function ‘AMF’ of the mobile core network.

In some embodiments, the mobile core network is a fifth-generation core network ‘5GC’.

FIG. 6 illustrates an embodiment of a method 600 in a user equipment apparatus.

A first step 610 comprises receiving, from a first application, a first request for a data connection, wherein the first request comprises one or more required connection capabilities.

A further step 620 comprises determining, based on the first request, that a multiaccess data connection is required for the data connection.

A further step 630 comprises transmitting, to a mobile core network of a wireless communication network, a second request for establishing the multiaccess data connection, wherein the second request comprises one or more traffic requirements that are based on the one or more required connection capabilities.

A further step 640 comprises receiving, from the mobile core network, a response to the second request, wherein the response comprises one or more steering rules for steering uplink traffic across a plurality of accesses of the multiaccess data connection, the one or more steering rules being based on the one or more traffic requirements.

In certain embodiments, the method 600 may be performed by a processor executing program code, for example, a microcontroller, a microprocessor, a CPU, a GPU, an auxiliary processing unit, a FPGA, or the like.

Some embodiments comprise steering uplink traffic, using the one or more steering rules, across the plurality of accesses of the multiaccess data connection.

In some embodiments, the determining that the multiaccess data connection is required, comprises: identifying a user equipment route selection policy ‘URSP’ rule matching the first request; and determining based on the URSP rule, that the multiaccess data connection is required.

In some embodiments, the one or more traffic requirements comprise one or more traffic descriptors of the URSP rule.

In some embodiments, the one or more traffic descriptors comprise traffic descriptors selected from the list of traffic descriptors consisting of: a high-bandwidth requirement; a low-latency requirement; and a high-reliability requirement.

In some embodiments, the one or more steering rules are access traffic steering, switching and splitting ‘ATSSS’ rules, wherein the ATSSS rules preferably comprise one or more steering modes selected from the list of steering modes consisting of: a load balancing steering mode; a smallest-delay steering mode; a redundant steering mode;
an active-standby steering mode; and a redundant steering mode.

In some embodiments, the multiaccess data connection session is a MA PDU session.

Some embodiments comprise, transmitting the second request to a SMF of the mobile core network; and receiving the response to the second request, from the SMF.

The disclosure herein further provides, a first apparatus in a wireless communication network, comprising a processor and a memory coupled with the processor, the processor configured to cause the first apparatus to: receive, from a SMF in the wireless communication network, a request for a session management policy for a multiaccess data connection, wherein the request comprises one or more traffic requirements that are based on one or more required connection capabilities; generate, based on the traffic requirements, one or more session management policy rules for steering traffic of the multiaccess data connection across a plurality of accesses of the multiaccess data connection; transmit, to the SMF, a response to the request for the session management policy, wherein the response comprises the one or more session management policy rules for steering the traffic of the multiaccess data connection.

In some embodiments, the one or more traffic requirements comprise one or more traffic descriptors of a URSP rule.

In some embodiments, the one or more traffic descriptors comprise traffic descriptors selected from the list of traffic descriptors consisting of: a high-bandwidth requirement; a low-latency requirement; and a high-reliability requirement.

In some embodiments, the first apparatus comprises a policy control function ‘PCF’.

In some embodiments, the multiaccess data connection is a MA PDU session.

In some embodiments, the mobile core network is a fifth-generation core network ‘5GC’.

FIG. 7 illustrates an embodiment of a method 700 in a first apparatus in a wireless communication network.

A first step 710 comprises receiving, from a SMF in the wireless communication network, a request for a session management policy for a multiaccess data connection, wherein the request comprises one or more traffic requirements that are based on one or more required connection capabilities.

A further step 720 comprises generating, based on the traffic requirements, one or more session management policy rules for steering traffic of the multiaccess data connection across a plurality of accesses of the multiaccess data connection.

A further step 730 comprises transmitting, to the SMF, a response to the request for a session management policy, wherein the response comprises the one or more session management policy rules for steering the traffic of the multiaccess data connection.

In certain embodiments, the method 700 may be performed by a processor executing program code, for example, a microcontroller, a microprocessor, a CPU, a GPU, an auxiliary processing unit, a FPGA, or the like.

In some embodiments, the one or more traffic requirements comprise one or more traffic descriptors of a URSP rule.

In some embodiments, the one or more traffic descriptors comprise traffic descriptors selected from the list of traffic descriptors consisting of: a high-bandwidth requirement; a low-latency requirement; and a high-reliability requirement.

In some embodiments, the first apparatus comprises a PCF.

In some embodiments, the multiaccess data connection is a MA PDU session.

The disclosure herein further provides, a second apparatus in a wireless communication network, comprising a processor and a memory coupled with the processor, the processor configured to cause the second apparatus to: transmit, to a PCF in the wireless communication network, a request for a session management policy for a multiaccess data connection, wherein the request comprises one or more traffic requirements that are based on one or more required connection capabilities; receive, from the PCF, a response to the request for the session management policy, wherein the response comprises one or more session management policy rules for steering the traffic of the multiaccess data connection across a plurality of accesses of the multiaccess data connection; and generate, based on the one or more session management policy rules, one or more steering rules for steering the traffic of the multiaccess data connection.

In some embodiments, the one or more steering rules comprise: one or more ATSSS rules for a user equipment apparatus, for steering uplink traffic of the multiaccess data connection; and/or one or more multiaccess N4 rules (MAR) for a user plane function (UPF), for steering downlink traffic of the multiaccess data connection.

In some embodiments, the processor is configured to cause the second apparatus to receive a request for a multiaccess data connection, wherein the request for the multiaccess data connection comprises the one or more traffic requirements.

In some embodiments, the multiaccess data connection is a MA PDU session.

FIG. 8 illustrates an embodiment of a method 800 in a second apparatus in a wireless communication network.

A first step 810 comprises transmitting, to a PCF in the wireless communication network, a request for a session management policy for a multiaccess data connection, wherein the request comprises one or more traffic requirements that are based on one or more required connection capabilities.

A further step 820 comprises receiving, from the PCF, a response to the request for the session management policy, wherein the response comprises one or more session management policy rules for steering the traffic of the multiaccess data connection across a plurality of accesses of the multiaccess data connection.

A further step 830 comprises generating, based on the one or more session management policy rules, one or more steering rules for steering the traffic of the multiaccess data connection.

In certain embodiments, the method 800 may be performed by a processor executing program code, for example, a microcontroller, a microprocessor, a CPU, a GPU, an auxiliary processing unit, a FPGA, or the like.

In some embodiments, the one or more steering rules comprise: one or more ATSSS rules for a user equipment apparatus, for steering uplink traffic of the multiaccess data connection; and/or one or more multiaccess N4 rules (MAR) for a UPF, for steering downlink traffic of the multiaccess data connection.

Some embodiments further comprise, receiving a request for a multiaccess data connection, wherein the request for the multiaccess data connection comprises the one or more traffic requirements.

In some embodiments, the multiaccess data connection is a MA PDU session.

FIG. 9 illustrates an embodiment 900 of an MA PDU establishment procedure. The embodiment 900 shows a UE 910 comprising an application 911 and an operating system 912. Further illustrated is a 5G-RAN 920 and a 5GC 930. The steps in establishing the MA PDU session will now be described. The steps 901-908 of FIG. 9 are modified from the equivalent steps 401-408 illustrated and described for FIG. 4. These steps are recited below for completeness, with particular emphasis on the differences to the equivalent steps of FIG. 4.

In a first step 901, the UE 910 operating system 912 receives a request from an internal application 911, which requests a data connection with one or more connection capabilities, e.g., with capability to support high-bandwidth, or with capability to support low-latency. This first step 901 is illustrated as, ‘data connection request (connection capabilities)’.

In a further step 902, after receiving the request from the application 911, the UE 910 (typically in the Operating System layer—912) processes the provisioned UE Route Selection Policy (URSP) rules and finds a rule matching the request. This matching rule may indicate that a new data connection (aka PDU Session) should be established using multiple accesses simultaneously, such as NG-RAN access and WiFi access. For example, the UE 910 may be provisioned with a URSP rule indicating that when a data connection is requested with connection capability equal to high-bandwidth, then a MA PDU session should be established. This rule aims at satisfying the high-bandwidth requirement by using multiple accesses and aggregating their bandwidths. This step 902 is illustrated as, ‘process URSP rules and trigger a request for a MA PDU session’.

In a further step 903, and triggered by the matching URSP rule, the UE 910 sends a MA PDU Session Establishment Request message to the 5GC 930 via 5G-RAN 920. In step 903, the MA PDU Session Establishment Request message sent by the UE 910 (see equivalent step 403 in FIG. 4) further contains Traffic Requirements or, more generally, information that assists the 5GC 930 to create steering rules for the MA PDU Session, which can support specific connection capabilities, e.g., high-bandwidth, low-latency, high-reliability, etc. The term Traffic Requirements is used in this disclosure, but different terms such as Steering Requirements, or Multiaccess Capabilities, or Connection Capabilities, or Traffic Capabilities, or ATSSS Assistance Information may also be utilized. As mentioned, this information aims at assisting the 5GC 930 to create steering rules for the MA PDU Session. The step 903 is illustrated in the Figure as, ‘MA PDU Session Est. Request, PDU Session ID, [S-NSSAI], [DNN], [PDU type], [SSC mode], 5GSM capability (ATSSS capabilities), traffic requirements’.

In a further step 904, the 5GC 930 processes the MA PDU session establishment request message and creates steering rules that specify how the UL and DL traffic should be routed across the multiple accesses of the MA PDU Session. In step 904, the MA PDU Session Establishment Request message, which now contains the Traffic Requirements, is received by an AMF in 5GC 930 and is forwarded to an SMF. In turn, the SMF forwards the Traffic Requirements to a PCF within the existing SM Policy Control Create Request message. Finally, the PCF now considers the received Traffic Requirements when creating the steering policy (i.e., the PCC rules) for the MA PDU Session and, in turn, the SMF creates the ATSSS and N4 rules based on the PCC rules created by PCF. This is illustrated in step 904 as, ‘create steering rules (ATSSS rules, N4 rules) based on network policy and UE subscription information, and based on the provided traffic requirements’.

As illustrated at 940 in FIG. 9, since the ATSSS rules and N4 rules are created based on the provided traffic requirements, the UL/DL data traffic of the application 911 is routed across multiple accesses in a way that satisfies the capabilities requested by the application 911.

In a further step 905, a MA PDU Session Establishment Accept message is sent to UE 910 via 5G-RAN 920 including Access Traffic Steering, Switching, Splitting (ATSSS) rules, which specify how the UL traffic should be routed across the multiple accesses. This step 905 is illustrated as, ‘MA PDU session est. accept, PDU session ID, PDU type, SSC mode, ATSSS container (ATSSS ru/es, etc)’. Similar rules, called N4 rules, are provided to a UPF in 5GC 930, which specify how the DL traffic should be routed across the multiple accesses.

In a further step 906, a data connection is established.

In further steps 907a-907b, and 908a-908b, by using the ATSSS rules in the UE 910 and the N4 rules in the UPF of 5GC 930, the UL and the DL traffic respectively is routed across the multiple accesses of the MA PDU Session. The further steps 907a-907b are illustrated as, ‘UL data traffic’ and ‘route UL data traffic across the multiple accesses based on the created ATSSS rules’ respectively. The further steps 908a-908b are illustrated as, ‘DL data traffic’ and ‘route DL data traffic across the multiple accesses based on the created N4 rules’ respectively.

Certain Traffic Requirements will now be described using examples. The Traffic Requirements may include the Traffic Descriptor of the URSP rule that triggered the establishment of the MA PDU Session. For example, the URSP rule that triggered the establishment of the MA PDU Session (i.e., the URSP rule matching the request from the application 911) may be the following:

```
URSP rule:
  Precedence=1
  Traffic Descriptor:
    Connection capabilities=high-bandwidth
  Route Selection Descriptor:
    Precedence=1
    SSC Mode Selection=SSC Mode 3
    Network Slice Selection=S-NSSAI-1
    Access Type Preference=Multiaccess.
```

This URSP rule indicates that the traffic of any application which requests a data connection with high-bandwidth capability, should be transferred over a MA PDU Session (as indicated by the Access Type Preference) that uses the network slice with identity S-NSSAI-1 and SSC mode 3. Based on this URSP rule, the UE 910 will send an MA PDU Session Establishment Request message (in step 903) with Traffic Requirements=Traffic Descriptor of the above URSP rule, i.e., Traffic Requirements={Connection capabilities=high-bandwidth}. Based on these Traffic Requirements, the PCF in 5GC 930 will create (in step 904) steering rules that increase the bandwidth offered by the MA PDU Session, e.g., will create a steering rule that routes all the MA PDU Session traffic over both NG-RAN access and WiFi access, with 50%-50% load balancing (i.e., a load-balancing steering mode will be selected).

In an alternative example, the Traffic Descriptor of the matching URSP rule may also include the identity of the application 911, which requested the data connection, as follows:

```
Traffic Descriptor:
  Application Id=com.example.app
  Connection capabilities=high-bandwidth
```

In this example, the Traffic Requirements will contain {Application Id=com.example.app, Connection capabilities=high-bandwidth} and the PCF in the 5GC 930 will create (in step 904) a steering rule that routes all traffic of this application 911 over both NG-RAN access and WiFi access, with 50%-50% load balancing. Hence, high bandwidth will be offered to the traffic of the application 911.

When the application 911 requests low-latency (instead of high-bandwidth), the Traffic Requirements may contain {Application Id=com.example.app, Connection capabilities=low-latency} and the PCF in the 5GC 930 will create (in step 904) a steering rule that routes all traffic of this application 911 over the access with the smallest delay (i.e., a smallest-delay steering mode will be selected for this application 911). Hence, low latency will be offered to the traffic of this application 911, since each data packet will be transferred over the access that features the smallest delay (as specified in the 3GPP specifications, a UE and a UPF can measure the delay over each access.)

As a further example, when the application 911 requests high-reliability (instead of high-bandwidth, or low-latency), the Traffic Requirements will contain {Application Id=com.example.app, Connection capabilities=high-reliability} and the PCF in the 5GC 930 will create (in step 904) a steering rule that duplicates all traffic of this application 911 over both access (i.e., a redundant steering mode will be selected for this application 911). Hence, high reliability will be offered to the traffic of this application 911.

In general, the Traffic Requirements may include the Traffic Descriptor of a URSP rule (as discussed above) or may include other information that assists the PCF in creating steering rules for the MA PDU Session. This information may be determined from the connection capabilities, which triggered the establishment for this MA PDU Session, such as, high-bandwidth, low-latency, high-reliability, etc.

This disclosure proposes novel enhancements to the MA PDU Session establishment procedure, which enables the 5GC network to create steering rules for the MA PDU Session that satisfy certain connection capabilities, e.g., the connection capabilities that triggered the establishment of the MA PDU Session. In particular, the disclosure proposes (a) to amend the MA PDU Session Establishment Request message to carry additional information (referred to as Traffic Requirements) that indicate connection/steering capabilities that should be supported by the MA PDU Session, and (b) to create the steering rules in the PCF by also considering this information.

The disclosure herein provides a UE that receives a first request (e.g., a request from an application in the UE) to establish a data connection, wherein the first request contains first connection capabilities (e.g., high-bandwidth, low-latency, high-reliability, etc.); identifies a first URSP rule, from a plurality of URSP rules provisioned in the UE, that matches the first request (e.g., matches the first connection capabilities and (optionally) matches the identity of the application sending the first request); determines, based on the first URSP rule, that the data connection should be established as a multiaccess data connection (i.e., MA PDU Session); transmits a PDU Session Establishment Request message, in response to determining that the data connection should be established as a multiaccess data connection, wherein the PDU Session Establishment Request message contains a multiaccess indicator and a first parameter (Traffic Requirements) derived from the first connection capabilities; and receives a PDU Session Establishment Accept message containing steering rules (ATSSS rules), the steering rules created using the first parameter.

Some embodiments further comprise the UE applying the ATSSS rules to decide how to steer the uplink traffic of the multiaccess data connection across the different accesses of the multiaccess data connection. Wherein the steering the uplink traffic of the multiaccess data connection across the different accesses of the multiaccess data connection is performed in accordance with the first connection capabilities.

The disclosure herein further provides a PCF, which applies the Traffic Requirements for creating the steering rules of the MA PDU Session.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, third generation partnership project; 5G, fifth generation; 5GC, 5G core; AMF, access management function; ATSSS, access, traffic, steering, switching, splitting; DL, downlink; MA, multiaccess; MMS, multimedia messaging service; MMTEL, multimedia telephony; NG RAN, next generation radio access network; OS, operating system; PCF, policy control function; PDU, protocol data unit; SMF, session management function; SSC, session and service continuity; UE, user equipment; UL, uplink; UPF, user plane function; URSP, UE route selection policy; and WLAN, wireless local area network.

1. A user equipment (UE) for wireless communication, comprising:
at least one memory; and
at least one processor coupled with the at least one memory and configured to cause the UE to:
receive a first request for a data connection, wherein the first request comprises one or more required connection capabilities;
determine, based at least in part on the first request, that a multiaccess data connection is required for the data connection;
transmit a second request for establishing the multiaccess data connection, wherein the second request comprises one or more traffic requirements that are based at least in part on the one or more required connection capabilities; and
receive a response to the second request, wherein the response comprises one or more steering rules for steering uplink traffic across a plurality of accesses of the multiaccess data connection, the one or more steering rules being based at least in part on the one or more traffic requirements.

2. The UE of claim 1, wherein the at least one processor is further configured to cause the UE to:
steer uplink traffic, using the one or more steering rules, across the plurality of accesses of the multiaccess data connection.

3. The UE of claim 1, wherein to determine that the multiaccess data connection is required, the at least one processor is configured to cause the UE to:
identify a UE route selection policy (URSP) rule matching the first request; and
determine, based at least in part on the URSP rule, that the multiaccess data connection is required.

4. The UE of claim 3, wherein the one or more traffic requirements comprise one or more traffic descriptors of the URSP rule.

5. The UE of claim 4, wherein the one or more traffic descriptors comprise one or more of:
a high-bandwidth requirement;
a low-latency requirement; or
a high-reliability requirement.

6. The UE of claim 1, wherein the one or more steering rules are access traffic steering, switching and splitting (ATSSS) rules, wherein the ATSSS rules comprise one or more of:
a load balancing steering mode;
a smallest-delay steering mode;
a redundant steering mode;
an active-standby steering mode; or
a priority-based steering mode.

7. The UE of claim 1, wherein the multiaccess data connection is a multiaccess protocol data unit (MA PDU) session.

8. The UE of claim 1, wherein to transmit the second request the at least one processor is configured to cause the UE to transmit the second request to a session management function (SMF) of a mobile core network, and wherein to receive the response to the second request, the at least one processor is configured to cause the UE to receive the response to the second request from the SMF.

9. An apparatus for wireless communication network, comprising:
at least one memory; and
at least one processor coupled with the at least one memory and configured to cause the apparatus to:
receive a request for a session management policy for a multiaccess data connection, wherein the request comprises one or more traffic requirements that are based at least in part on one or more required connection capabilities;
generate, based at least in part on the traffic requirements, one or more session management policy rules for steering traffic of the multiaccess data connection across a plurality of accesses of the multiaccess data connection;
transmit a response to the request for the session management policy, wherein the response comprises the one or more session management policy rules for steering the traffic of the multiaccess data connection.

10. The apparatus of claim 9, wherein the one or more traffic requirements comprise one or more traffic descriptors of a user equipment route selection policy (URSP) rule.

11. The apparatus of claim 10, wherein the one or more traffic descriptors comprise one or more of:
a high-bandwidth requirement;
a low-latency requirement; or
a high-reliability requirement.

12. The apparatus of claim 9, wherein the apparatus implements a policy control function (PCF).

13. The apparatus of claim 9, wherein the multiaccess data connection is a multiaccess protocol data unit (MA PDU) session.

14. An apparatus for wireless communication network, comprising:
at least one memory; and
at least one processor coupled with the at least one memory and configured to cause the apparatus to:
transmit a request for a session management policy for a multiaccess data connection, wherein the request comprises one or more traffic requirements that are based at least in part on one or more required connection capabilities;
receive a response to the request for the session management policy, wherein the response comprises one or more session management policy rules for steering the traffic of the multiaccess data connection across a plurality of accesses of the multiaccess data connection; and
generate, based at least in part on the one or more session management policy rules, one or more steering rules for steering the traffic of the multiaccess data connection.

15. The apparatus of claim 14, wherein the one or more steering rules comprise at least one of:
one or more access traffic steering, switching and splitting (ATSSS) rules for a user equipment (UE) for steering uplink traffic of the multiaccess data connection; or
one or more multiaccess N4 rules for a user plane function (UPF) for steering downlink traffic of the multiaccess data connection.

16. The apparatus of claim 14, wherein the at least one processor is further configured to cause the apparatus to:
receive a request for a multiaccess data connection, wherein the request for the multiaccess data connection comprises the one or more traffic requirements.

17. The apparatus of claim 14, wherein the multiaccess data connection is a multiaccess protocol data unit (MA PDU) session.

18. A method performed by a user equipment (UE), the method comprising:
receiving a first request for a data connection, wherein the first request comprises one or more required connection capabilities;
determining, based at least in part on the first request, that a multiaccess data connection is required for the data connection;
transmitting a second request for establishing the multiaccess data connection, wherein the second request comprises one or more traffic requirements that are based at least in part on the one or more required connection capabilities; and
receiving, a response to the second request, wherein the response comprises one or more steering rules for steering uplink traffic across a plurality of accesses of the multiaccess data connection, the one or more steering rules being based at least in part on the one or more traffic requirements.

19. The method of claim 18, further comprising:
steering uplink traffic, using the one or more steering rules, across the plurality of accesses of the multiaccess data connection.

20. The method of claim 18, wherein the determining that the multiaccess data connection is required, comprises:
identifying a UE route selection policy (URSP) rule matching the first request; and
determining based at least in part on the URSP rule, that the multiaccess data connection is required.
